(19) United States
(12) Patent Application Publication
(10) Pub. No.: US 2002/0113686 A1
(43) Pub. Date: Aug. 22, 2002

(54) Transceiver and related method

(75) Inventor: Shannon Ludwig Shannon Carravallah, White Lake, MI (US)

Correspondence Address: Stephen T. Sullivan, Sullivan Law Group, 5060 N. 40th Street, Suite 120, Phoenix, AZ, 85018, US

(73) Assignee: Ludwig Laboratories, Inc.

(21) Appl. No.: 09/791,310

(22) Filed: Feb. 22, 2001

(51) Int. Cl. H04Q 1/00; G08B 5/22

(52) U.S. Cl. 340/5.61; 340/7.1

(57) ABSTRACT

A transceiver is provided for transmitting and receiving signals. The transceiver includes a first receiver for receiving at least one actuation request. Each actuation request includes a first signal for requesting the transceiver to transmit an actuation command corresponding to the actuation request. The transceiver further includes a transmitter for transmitting at least one actuation command including the actuation command corresponding to the at least one actuation request. Each actuation command includes a second signal having a signal format. The transceiver further includes a controller in operative communication with the first receiver and the transmitter for controlling the operation of the transceiver.

### BACKGROUND OF THE INVENTION

1. Field of the Invention

The present invention relates to devices and methods for the control of components, and, more specifically the present invention relates to devices and methods for the wireless control of components remotely.

2. Description of the Related Art

Remote controls for controlling the operation of devices have become an integral part of our every day life. Remote controls for televisions, record and play devices such as VCR's and tape recorders, stereo systems, digital video devices, garage door openers, community gate openers, thermostats, car alarm systems, car starters, etc. are virtually everywhere. Generally these devices are only capable of operating over short distance. That is, they can only direct the operation of the devices or components that they control over short distances, typically less than 100 feet away from their subordinate device. In many cases the remote control needs to be within as little as 20 or 30 feet of its corresponding subordinate device. There are various reasons for this, including the need to keep one remote control from actuating another device which it is not intended to actuate. For example, a garage door opener remote control owned by one home owner could potentially open the garage door of another home owner a large distance away if the remote control had too long a transmission distance capability. The home owner using the remote control would not necessarily even know he had opened another home owners garage, potentially leaving the second home open for theft. Another reason that remote controls generally are short distance devices is to limit power consumption. Longer distance transmission consumes larger amounts of power, limiting remote control battery life. There are also Federal Communications Commission restrictions on the power level allowed for radio frequency remote controls. This further restricts the distance over which a remote control can command a subordinate device.

Generally short distance remote controls use one of two different types of wireless communication medium, infra-red communication and radio frequency communication. These short distance devices are inoperative at distances over about ¼ or ½ mile, and generally, most of these devices only work over distances of several hundred feet or less. Most indoor home appliance remote controls, such as those for audio and video components, tend to use an infra-red medium to transmit the command signals from the remote control to the subordinate component. This is generally because the subordinate components are usually within a direct line of sight of the user of the remote control. This allows for the use of infra-red communication signals between the remote control and the component. Infra-red communication generally requires a direct line of sight to the subordinate component to allow the component to receive the signal. In this case, the infra-red signal is the preferred medium because it generally consumes less power in transmitting the signal and it does not have as many restrictions on the signal characteristics because it does not fall under the control of the Federal Communications Commission. Outdoor remote control devices, on the other hand, are generally radio frequency devices. This is because most of these devices typically are used when there is no direct line of sight between the remote control device and its subordinate component when the remote control is actuated. This is because most of these devices are for opening doors, such as garage doors or gates, or for starting cars that are outside from inside a building or house.

Another recent development in the area of remote controls involves smart, or trainable remote controls. Because many electronic components include a remote control when purchased, this leaves the end user of these components with multiple different remote controls. It becomes difficult to remember which remote control is for use with each component. Additionally, just storing the remote controls in a convenient location for use becomes difficult with the number of different remote controls an individual accumulates with the various electronic components he may own. For example, for a video system alone the owner often has a remote control for their television, another remote control for their video tape recorder and player, another remote control for their digital video disk player, and another remote control for their cable or satellite television control box. If the individual is unfortunate enough to have incorporated their audio system into their video system, they most likely will also have a remote control for their receiver, a remote control for their compact disk player, and a remote control for their tape deck. The owner of an audio video home theater system can easily have 7 or 8 different remote controls for one home theater system. The space taken up by these various remote controls and the confusion associated with using them can very quickly out weighs the intended benefit and convenience of these devices. This doesn't even begin to address the fact that if an individual has more than one audio or video system, that each system may have its own set of remote controls that are incompatible with the remote controls for the same components in the other systems. As a result, trainable remote controls that can learn the output signal characteristics of other remote control devices have become popular. With a trainable or smart remote control, an individual can use his existing remote controls to provide model signals to teach the trainable remote control the signal characteristics of his existing remote controls. This allows the individual to use the trainable remote control to learn the characteristics of all the various remote controls associated with one or more of his systems, for example, his or her home theater system. This way the individual can use the trainable remote control as a single remote control to operate his or her entire system. The trainable remote controls are common in both the infra-red and the radio frequency medium of communication. U.S. Pat. No. 4,825,200 assigned to Tandy Corporation and U.S. Pat. No. 5,614,885 assigned to Prince Corporation are examples of both of these types of trainable remote controls, respectively.

Radio frequency communication devices have long been used to transmit communication signals using radio frequency transmissions. These devices can support rather long distance communications, often on the order of many miles. Devices of this type include pagers, cellular telephones, portable radios, etc. Some of these devices, such as pagers, only support reception of signals, and some of them, such as cellular telephones and portable two way radios, support reception and transmission of signals. Generally these long distance devices are capable of transmitting wireless communications over distances exceeding the ½ mile maximum distance of the short distance wireless devices, and more often far exceeding this limit. The distance over which many of these devices can communicate is greatly increased by an infrastructure of relay stations, as is the case for cellular telephones and pagers. These relay stations also communicate with other transmission systems including telephone lines, cable lines, and satellite relay systems, thus allowing these longer distance wireless devices to receive, and if supported by the device transmit, communications essentially across the world. The actual wireless communication distance may be short if the receiving device is close to a transmitter or radio tower, even though the actual signal may be coming from across the world. In some cases these devices have been used to provide actuation signals or contacts for controlling or actuating processes. U.S. Pat. No. 5,608,655 assigned to Motorola, Incorporated, for example, discloses a pager including programmable analog and digital control outputs.

There have been attempts at using longer distance wireless communications to actuate a car starter via audio communication between the long distance wireless device and a car starter. U.S. Pat. No. 5,129,376 to Parmley describes a remote control car starter actuated by the audio output signal from a conventional pager. The device described in that patent actuates a car's ignition system when it recognizes the audio “beeping” output of a pager. This configuration has the disadvantage of requiring the installation of a custom car starter system, and it also potentially may attempt to start the car inadvertently if a pager goes off in its vicinity, even if the paging signal is not intended to start the vehicle.

Known remote control devices are limited by the distance over which they can operate. Trainable known remote control devices offer the advantage of using one remote control device for multiple subordinate components, but they do nothing to allow the long distance control of a subordinate component. Known remote control devices only provide for the short distance actuation of devices.

### OBJECTS OF THE INVENTION

Accordingly, an object of the present invention is to provide a method and device for controlling components remotely.

Another object of the present invention is to provide a method and device for the wireless control of components.

Another object of the present invention, according to one aspect, is to provide a method and device for learning the signal format of other remote control devices.

Another object of the present invention, according to another aspect, is to provide a method and device for controlling components from a long distance.

Another object of the invention is to provide a method and device for controlling components remotely with low power consumption.

### SUMMARY OF THE INVENTION

To achieve the foregoing objects, and in accordance with the purposes of the invention as embodied and broadly described in this document, in accordance with on aspect of the invention a transceiver for transmitting and receiving signals is provided. The transceiver comprises a first receiver for receiving at least one actuation request. Each actuation request comprises a first signal for requesting the transceiver to transmit an actuation command corresponding to the actuation request. The transceiver further comprises a transmitter for transmitting at least one actuation command including the actuation command corresponding to the at least one actuation request. Each actuation command comprises a second signal having a signal format. The transceiver further comprises a controller in operative communication with the first receiver and the transmitter for controlling the operation of the transceiver.

In the preferred embodiments, the transceiver further comprises a second receiver for receiving at least one model signal and each model signal comprises a radio frequency signal having the signal format corresponding to one of the at least one actuation commands. In this preferred embodiment the controller is further in operative communication with the second receiver and is for controlling the operation of the transceiver. The controller of this embodiment is operable to control the transceiver in a training mode. The transceiver learning the signal format for the at least one actuation command in the training mode by receiving with the second receiver the at least one model signal and learning the signal format of the model signal.

Further in accordance with the preferred embodiments, the transceiver further comprises an operator interface operatively coupled to the controller. Preferably the operator interface comprises at least one switch, and more preferably the at least one switch comprises a momentary switch. Preferably the operator interface includes at least one switch for transmitting the at least one actuation command when the switch is actuated.

Further in accordance with the preferred embodiments, the transceiver comprises a remote control for remotely actuating one or more devices using the at least one actuation command. Preferably transceiver comprises a vehicle remote control for remotely starting a vehicle using the at least one actuation command and more preferably the actuation request comprises a request for transmitting the actuation command corresponding to the actuation request for remotely starting the vehicle. Preferably the vehicle comprises an automobile. Alternately, but preferably the transceiver comprises a remote control for opening a door using the at least one actuation command. Preferably the first signal comprises a long distance radio frequency signal and more preferably the first signal comprises a paging signal.

Further in accordance with the preferred embodiments, the actuation command corresponding to the actuation request comprises a short distance radio frequency signal, and preferably the short distance radio frequency signal is a command to start a vehicle. Preferably the actuation command comprises a command to start a vehicle, and more preferably the actuation command corresponding to the actuation request comprises a command to start a vehicle.

Further in accordance with the preferred embodiments, the second signal comprises a short distance radio frequency signal. Preferably the first receiver comprises a radio frequency antenna. Preferably the transmitter comprises a radio frequency antenna, and preferably the second receiver comprises a radio frequency antenna. In some of the preferred embodiments the first receiver and the second receiver comprise a single radio frequency antenna. In the preferred embodiments the first receiver, the second receiver, and the transmitter may comprise a single radio frequency antenna.

Further in accordance with the preferred embodiments the controller comprises a paging signal decoder. Preferably the controller comprises a signal generator. Preferably the controller comprises a microprocessor. In the preferred embodiments the transceiver comprises a single enclosure.

In accordance with another aspect of the invention, a transceiver is provided for transmitting and receiving signals. The transceiver comprises a first receiver for receiving at least one actuation request. Each actuation request comprises a first signal for requesting the transceiver to transmit an actuation command corresponding to the actuation request. The transceiver further includes a transmitter for transmitting at least one actuation command including the actuation command corresponding to the at least one actuation request. Each actuation command comprises a second signal having a signal format. The transceiver according to this aspect of the invention further comprises a second receiver for receiving at least one model signal. Each model signal comprises a radio frequency signal having the signal format corresponding to one of the at least one actuation commands. The transceiver further comprises a controller in operative communication with the first and second receivers and the transmitter for controlling the operation of the transceiver. The controller being operable to control the transceiver in a training mode and an active mode. The transceiver learning the signal format for the at least one actuation command in the training mode by receiving with the second receiver the at least one model signal and learning the signal format of the model signal. The transceiver receiving the at least one actuation request and transmitting the at least one actuation command including the actuation command corresponding to the at least one actuation request in the active mode.

In the preferred embodiments according this aspect of the invention, the transceiver further includes an operator interface operatively coupled to the controller. Preferably the transceiver comprises a remote control for remotely actuating one or more devices using the at least one actuation command. Preferably the transceiver comprises a vehicle remote control for remotely starting a vehicle using the at least one actuation command. Preferably the actuation request comprises a request for transmitting the corresponding actuation command for remotely starting the vehicle.

Further in accordance with the preferred embodiments the first signal comprises a long distance radio frequency signal, and more preferably the first signal comprises a paging signal. Preferably the actuation command corresponding to the actuation request comprises a short distance radio frequency signal, and more preferably the short distance radio frequency signal comprises a command to start a vehicle. Preferably the second signal comprises a short distance radio frequency signal. Preferably the first receiver, the second receiver, and the transmitter comprise a radio frequency antenna.

In accordance with another aspect of the invention, a method is provided for using a transceiver to control a device remotely. The method comprises receiving at least one actuation request at the transceiver. Each actuation request comprises a first signal requesting the transceiver to send an actuation command corresponding to the actuation request. The method further comprises using the transceiver to send at least one actuation command including the actuation command corresponding to the at least one actuation request. Each actuation command comprises a second signal having a signal format.

In the preferred embodiments according to this aspect of the invention, the method further comprises receiving at least one model signal at the transceiver. Preferably each model signal has a signal format corresponding to one of the at least one actuation commands. The transceiver preferably learns the signal format of the model signal in a training mode. Preferably the transceiver further includes an operator interface operatively coupled to the transceiver. Preferably the at least one actuation command comprises a command to start a vehicle remotely. Preferably the actuation request comprises a request for transmitting the corresponding actuation command for remotely starting the vehicle.

Further in accordance with the preferred embodiments of this aspect of the invention, the first signal comprises a long distance radio frequency signal, and more preferably the first signal comprises a paging signal. Preferably the actuation command corresponding to the actuation request comprises a short distance radio frequency signal. Preferably the second signal comprises a short distance radio frequency signal. Preferably the transceiver further includes an antenna for sending or receiving at least one of the first signal, the second signal, and the model signal.

### BRIEF DESCRIPTION OF THE DRAWINGS

The accompanying drawings, which are incorporated in and constitute a part of the specification, illustrate presently preferred embodiments and methods of the invention and, together with the general description given above and the detailed description of the preferred embodiments and methods given below, serve to explain the principles of the invention.

FIG. 1 depicts a transceiver according to a presently preferred embodiment of the invention in use with a vehicle;

FIG. 2 is a simple block diagram of one of the presently preferred embodiments;

FIG. 3 is a simple block diagram of another one of the presently preferred embodiments;

FIG. 4 is a wiring diagram for versions of preferred embodiments as described below.

### DETAILED DESCRIPTION OF THE PREFERRED EMBODIMENTS AND METHODS

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiment and method. The invention according to its various aspects is particularly pointed out and distinctly claimed in the attached claims read in view of this specification, and appropriate equivalents.

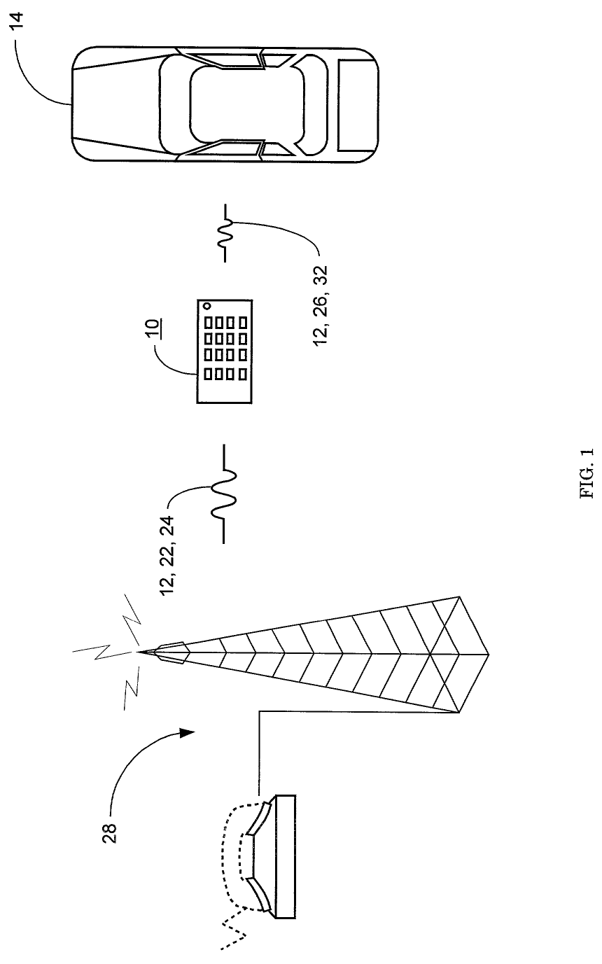

In accordance with one aspect of the invention, a transceiver is provided for transmitting and receiving signals. In accordance with the preferred embodiments according to this aspect of the invention, a transceiver 10 is provided for transmitting and receiving signals 12 that are wireless signals such as radio frequency signals and optical signals such as infra-red light signals, as shown in FIGS. 1-4. The transceiver 10 is particularly useful as a remote control for subordinate components and devices 14 such as vehicle starting circuits as are common in the automotive industry, vehicle alarm circuits, door and gate control such as garage door openers, etc., as will be described in more detail below. These devices are typically controlled by radio frequency signals, but the transceiver 10 may also be used with other types of wireless signals 12, such as infra-red signals or any other variety of wireless signal, such as audio signals or other such wireless communication signals. As the term is used herein, a wireless signal refers to a signal transmitted by a medium not requiring a hard wired connection. In the preferred embodiments according to the invention, the wireless signal can comprise an electromagnetic signal such as radio frequency signal or an optical signal, for example infra-red, although any wireless signal medium may be used as contemplated herein. The preferred signal is a radio frequency signal in the frequency range as is commonly used for remote control devices such as remote automotive starter systems, automotive alarm systems, door or gate openers such as garage door openers, pager devices, etc. These devices typically operate in the frequency range of about 100 MHz to 500 MHz. Preferably, all of the components of the transceiver 10 are contained in a single housing or case, much the same as known remote controls. This makes the transceiver more convenient to handle.

The transceiver 10 according to one of the presently preferred embodiments is a trainable transceiver and is preferably capable of learning the signal characteristics of another wireless remote control device, such as a car starter remote control or a garage door opener, and subsequently transmit a signal with similar characteristics after learning the signal characteristics of the model remote control device, as will be described in more detail below.

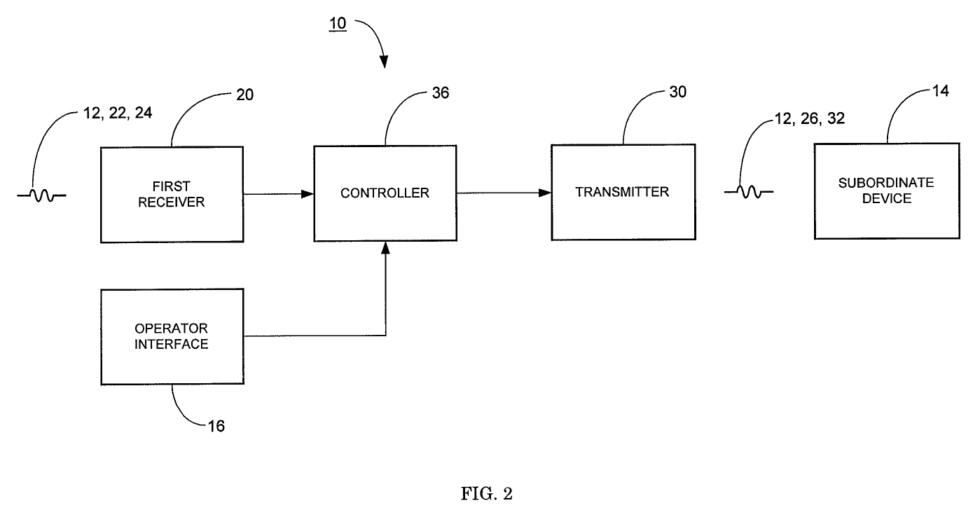

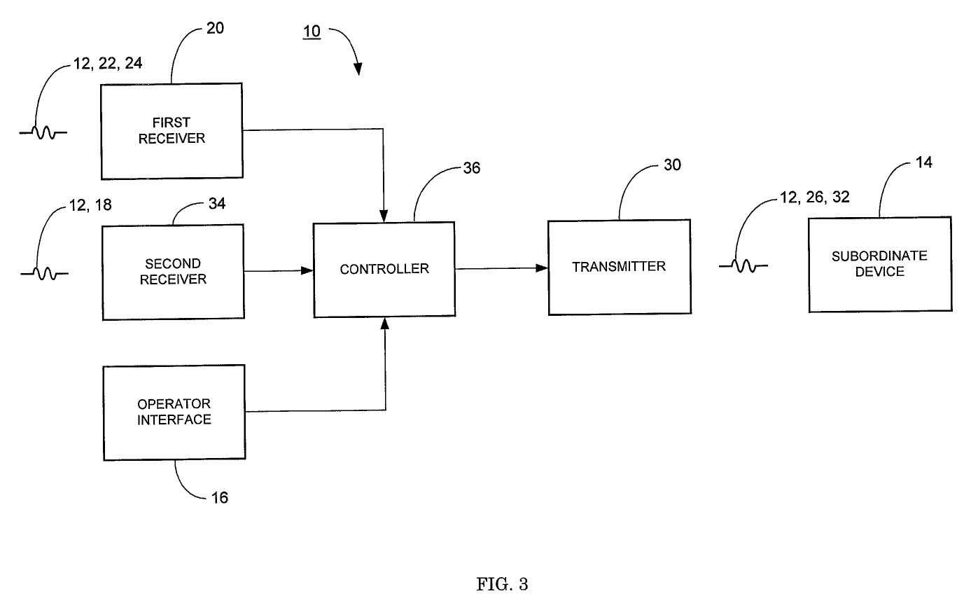

Preferably, the transceiver 10 includes an operator interface 16 as shown in FIGS. 2 and 3, to allow an operator to manually access the transceiver for transmitting actuation commands, training the transceiver 10, programming the transceiver with the various codes for the actuation requests, etc., in accordance with the various preferred embodiments of the transceiver, as will be described in more detail below. The operator interface 16 can be any form of interface allowing an operator to manually interface the transceiver 10. The preferred operator interface includes a keypad with one or more momentary switches, much the same as those used on common wireless remote controls. The operator interface may also include one or more non-momentary switch. The non-momentary switches may be used, for example, to hold the transceiver in training mode or in active mode, while an operator is using the transceiver in that mode. The preferred embodiments of the transceiver 10 include an operator interface keypad with more than one momentary switch.

The transceiver 10 preferably is for use as a remote control. One of the presently preferred embodiments uses for the transceiver of the invention for starting vehicles, for example land vehicles such as automobiles, trucks, motor cycles and the like. The term automobile as used herein means any standard roadway transportation vehicle such as cars, small trucks, and the like, such as those sold to individuals in the consumer automotive market. There are a large number of vehicles with short distance remote control starters. These systems allow the vehicle user to start the vehicle at a short distance to allow the vehicle to warm up so that it is fully warmed up and ready for use when the driver enters the vehicle. These vehicle remote starter systems are especially common in colder climates, where the vehicle can be very cold and sluggish for a significant period of time after the vehicle is started. This is uncomfortable for the driver of the vehicle, as the environmental heating system of the vehicle has not heated to the point where the occupant compartment is warm. It also allows the vehicle to warm to the point that any heater system window defrosters have melted any ice, frost, or snow off of the window so that the driver can see. It also allows the vehicle's engine to warm up to the point where it has reached an optimum, or at least improved, operating efficiency.

These advantages make vehicle starter remote controls very popular in certain territories. Unfortunately, most of these devices can operate only over very short distances. They do not allow a vehicle user to start their vehicle at a distance, for example, in the parking lot at work, or at the store, or even in a parking lot at their apartment or condominium complex. This is because most of the known vehicle starter remote controls are short distance devices and typically are only capable of starting the vehicle if it is less than about 50 or 100 feet from the user's location. These known short distance vehicle remote control devices are also typically affected by obstacles and are typically not as effective in transmitting a successful vehicle start command if there are obstacles such as walls and buildings between the remote control and the vehicle. In the preferred embodiments of the invention, the transceiver 10 accepts long distance actuation requests to start a vehicle and transmits a short distance actuation command to start the vehicle, as will be described in more detail below. In accordance with one of the presently preferred embodiments, transceiver preferably learns a model signal 18, as depicted in FIG. 3, that is an actuation command of an existing short distance vehicle remote control in a training mode, so the transceiver can send an actuation command with the same signal format as that from the existing short distance vehicle remote control. Thus, once the trainable transceiver has been trained to imitate the model signal 18 of the existing short distance vehicle remote starter, the trainable transceiver embodiment of the invention can start the vehicle by imitating the existing remote control's signal.

In the preferred embodiments, the transceiver 10 can be actuated by a long distance radio frequency actuation request and transmit the corresponding actuation command. Therefore, the trainable transceiver preferred embodiment of the invention is especially useful for starting vehicles with existing short distance vehicle remote starter systems at long distances. A vehicle user with an existing short distance vehicle remote starter system can use the trainable preferred embodiments of the invention to start his or her vehicle from a long distance. All he or she need to do to accomplish this is to train the trainable transceiver to learn the signal format of the user's existing remote control, and leave the trainable transceiver in the vehicle. In this preferred embodiment of the invention, when the user wants to start the vehicle at a long distance, the user simply accesses the long distance actuation circuit, for example, through the use of a pager access number, enters the access code for the actuation request corresponding to the actuation command to start the vehicle, and the transceiver 10 transmits the actuation command to start the vehicle, as will be described in more detail below. Since the transceiver is in the vehicle and a short distance from the remote starter circuit of the vehicle, the vehicle starts when the transceiver 10 transmits the actuation command to start the vehicle. In this manner, owners of existing short distance vehicle remote starters can extend the capability of their remote starter system very easily.

The preferred embodiments of the transceiver 10 also include an operator interface 16, and more preferably the transceiver is capable of being trained to transmit more than one different actuation command, as will be described in more detail below. The operator interface allows the operator to transmit the actuation commands manually, as desired. The some of the preferred embodiments of the transceiver 10 are capable of transmitting multiple actuation commands, and the actuation commands may be transmitted by either receiving and actuation request with the first receiver, or by using the operator interface 16 to manually direct the transceiver to transmit the actuation command. Each actuation commands do not necessarily have a corresponding actuation request, and not every actuation command needs to be able to be manually transmitted through the use of the operator interface. There may be certain actuation commands that can only be interfaced through the operator interface and other actuation commands that may only be interfaced or requested through the use of the actuation requests. The actuation commands may also be accessed by both the operator interface and the actuation requests. The transceiver of the invention is not intended to be limiting in this regard. The only requirement is that at least one of the actuation commands correspond to an actuation request so that the command can be initiated remotely at a long distance. Therefore, the actuation commands corresponding to an actuation request represent a first actuation command, and the preferred embodiments of the transceiver can transmit the first actuation commands, but they may also be able to transmit other actuation commands that do not correspond to any actuation request.

In the case of the trainable preferred embodiments of the transceiver 10, the user can utilize the trainable transceiver to learn other actuation commands of devices already owned by the user, for example, garage door openers, or community gate openers, or even the vehicle start command for another vehicle with a vehicle starter remote that the user owns or has access to. This way a user can train trainable transceivers according to this aspect of the invention so the transceiver 10 can be used to remotely start his vehicle, and the user can leave the device in the vehicle and also use it, either manually through operator interface unit or long distance using the actuation request, to open his garage door, or his community gate, etc. This eliminates the user's need for multiple remote control devices.

The transceiver 10 of the preferred embodiments of the invention offers all the benefits of known remote control devices, as well as the added capability of remotely actuating devices from long distances using the long distance actuation requests, as will be described in more detail below.

Further in accordance with this aspect of the invention, the transceiver includes a first receiver for receiving at least one actuation request. Each actuation request comprises a first signal for requesting the transceiver to transmit an actuation command corresponding to the actuation request. In the preferred embodiments according to this aspect of the invention, the first receiver 20 is for receiving actuation requests 22 that are wireless electromagnetic signals, such as radio frequency or optical signals, as was described in detail previously and shown in FIGS. 1-4. More preferably, the first receiver 20 is a for receiving long distance radio frequency signals, and the first receiver includes a radio frequency antenna for the reception of these signals, as will be described in more detail below. The actuation request 22 is preferably a first signal 24 that is an encoded signal that requests the transceiver 10 to respond by transmitting an actuation command 26 corresponding to the specific actuation request received, as will be described in more detail below. The first signal transmitting the actuation request is preferably transmitted over long distance wireless communication network 28, such as a paging network or a cellular phone network, as described previously. These networks have the necessary infrastructure to transfer the first signal over very long distances, essentially anywhere in the world, again as previously described. The long distance radio frequency signals are capable of being transmitted over distance of ½ mile or greater, as described previously.

Each actuation request 24 comprises a request to the transceiver 10 to transmit an actuation command 26 corresponding to the actuation request as shown in FIGS. 1-4, and preferably the transceiver is capable of processing one or more actuation request. For example, one actuation request 24 may request the transceiver 10 to transmit an actuation command 26 for activating the starter circuit on a vehicle and another actuation request may be an actuation request to the transceiver to transmit the actuation command to set off the alarm on a vehicle. A third actuation request may be a request to the transceiver to transmit the actuation command to open a garage door, etc. In the preferred embodiments according to this aspect of the invention the transceiver 10 is capable of responding to more than one actuation request 24. This is especially useful for the preferred embodiments of the invention where the transceiver 10 is a trainable transceiver, where the transceiver can learn the signal format of a variety of existing remote control devices belonging to the user. This allows the transceiver to be used for more applications, making it more versatile and flexible for the end user.

In the preferred embodiments according to this aspect of the invention, the first signal 22 comprises a radio frequency signal as described previously, and preferably the first signal is a long distance radio frequency signal capable of being transmitted over long distances, as described previously. Such long distance signals include cellular phone signals, two way radio signal, paging signals, etc. The preferred signal type for the first signal 22 is a paging signal for activation of a paging device, as is commonly used in the telecommunication industry today. This allows the actuation request to be transmitted accurately over very long distances. It also allows the actuation request 24 to be encoded. The use of the current infrastructure for paging devices provides a good level of security so that it is unlikely that an actuation request can be inadvertently transmitted to the transceiver 10. First, an inadvertent user must dial into the correct paging phone number to access the transceiver. The transceiver preferably is programmed or designed only to recognize a correct paging instruction. For example, current paging devices can support the transmission of many digits of numerical code, including 10 or more digit phone numbers as well as additional digits for messages. This allows the actuation request 24 to be encoded with a very large number of digits providing for greater security. It is easily conceivable that an actuation code of 12 or more digits could be used to encrypt the actuation request. This makes the likelihood of inadvertent actuation of the transceiver 10 essentially impossible. For the transceiver to be inadvertently actuated, first an inadvertent user would need to dial into the correct pager number, which requires ten digits, including area code, to correctly access the transceiver. After inadvertently dialing into the page number corresponding to the transceiver, the individual would need to enter the correct actuation code, which may be as few as 1 digit, but could easily be 12 or more digits. If a large number of digits are used for the actuation request code, the probability of inadvertent actuation can easily be reduced to far less than a one in one billion probability. The use of a security code with a number of digits not corresponding to a standard phone number (not 7 or 10 digits) further decreases the possibility of inadvertent actuation, since most individuals accidentally accessing the pager number corresponding to the transceiver are most likely trying to enter a phone number into a another pager.

The actuation command 26 according to the preferred embodiments comprises a short distance wireless signal that is preferably an electromagnetic signal such as a radio frequency signal or an optical signal, as described previously. Preferably, the actuation command is a short distance radio frequency signal that comprises a remote actuation command, such as a remote actuation command to start a vehicle, activate a vehicle alarm, or actuate a gate or door such as a garage door or community gate, as described in detail previously. The short distance wireless signals are only capable of being transmitted over distances of less than about ¼ or ½ mile, and generally on the order of only hundreds of feet or less, as described in detail previously. The preferred embodiments of the transceiver 10 are remote controls for starting vehicles such as automobiles or cars, and for actuating car alarms, and automotive accessories and devices. The preferred embodiments of the transceiver also include remote controls that may also be used for opening garage doors and community gates. Thus, the actuation commands 26 are preferably short distance radio frequency remote control commands, and the actuation requests 24 are preferably long distance radio frequency requests to the transceiver to transmit the corresponding short distance radio frequency actuation command.

Further in accordance with this aspect of the invention, the transceiver includes a transmitter for transmitting at least one actuation command including the actuation command corresponding to the at least one actuation request. Each actuation command is a second signal having a signal format. In the preferred embodiments of the invention according to this aspect of the invention, the transmitter 30 includes a radio frequency antenna for transmitting the actuation commands 26, and the actuation commands are a second signal 32 that is preferably a short distance radio frequency remote control signal, as described in detail previously and depicted in FIGS. 1-4. Alternately, the transmitter 30 may include an optical or acoustical transducer such as a light emitting diode or a speaker for transmitting a short distance wireless signal by optical or acoustical means. Infra-red light emitting diodes are commonly used on indoor electronic equipment for short distance remote control. The transceivers 10 according to the preferred embodiments of the invention could easily be adapted to use any of these means for the transmission of the actuation command 26, as described previously. The transmitter's radio frequency antenna in the preferred embodiments could be the same antenna as that used for the first receiver 20, or it could be a different antenna. This depends upon a number of factors, including the frequency of the signals 12 to be received and transmitted, the power level of these signals, the cost of adapting the antenna to be capable of handling both the reception of the actuation requests 24 and the transmission of the actuation commands 26, etc. In the preferred embodiments, the actuation requests 24 are long distance radio frequency paging signals and the actuation commands 26 are short distance radio frequency remote control signals. Due to the differences in frequency, power, and signal type between these two signals, it is probably most cost to use two different antennas for these two different signals.

As described previously, each actuation command 26 is a second signal 32 that is preferably a short distance wireless signal such as an electromagnetic or acoustic signal, and is more preferably a short distance radio frequency signal. As is well known to those in the art of remote control design, or even wireless technology design, each wireless signal has a signal format. In the preferred embodiments of the transceiver 10, the second signal 32 has a signal format. The signal format provides the characteristics of the signal necessary to communicate the intent or meaning of the signal. Each actuation command 26 has a signal format uniquely defining the signal and its intended action. Much like the phonetics defining the words in a language and their associated meaning, the signal format of the second signal 32 transmitting the actuation command defines the associated meaning and intent of the actuation command. The transceiver 10 of the preferred embodiments is capable of producing anywhere from one up to large number of signal formats, for example, the trainable preferred embodiments of the transceiver can produce a large number of signal formats by varying the frequency, modulation, and encryption of the second signal transmitting the actuation command. This is well known in the art of remote control design and trainable remote control design. U.S. Pat. Nos. 5,442,340, 5,475,366, 5,479,155, 5,614,885, 5,627,529, 5,646,701, 5,854,593, and 5,903,326, all assigned to Prince Corporation, describe in detail radio frequency signal formats or characteristics for remote controls as well as the known of radio frequency trainable remote controls. The trainable transceiver embodiments include trainable remote control circuitry and software similar to that in the known trainable remote control devices, such as that described in the aforementioned U.S. patents assigned to Prince Corporation.

In some of the preferred embodiments of the invention, the transceiver 10 includes a second receiver 34 for receiving at least one model signal 18, as shown in FIG. 3. Each model signal comprises a radio frequency signal having the signal format corresponding to one of the at least one actuation commands 26. In these preferred embodiments, the second receiver 34 is for receiving model signals 18 from other remote control devices so that the trainable embodiments of the transceiver 10 can learn the signal format of the model signals and duplicate them when called upon to do so in the future. In the preferred embodiments, the model signals 18 are short distance radio frequency signals such as remote control signals for starting vehicles, actuating vehicle alarms, or opening gates or doors, as described in detail previously. The second receiver 34 preferably includes an antenna for receiving short distance remote control radio frequency signals so that the transceiver 10 can learn the signal format of these signals to mimic them, as will be described in detail below. Alternately, the second receiver 34 could include an optical or acoustical transducer or some other variety of wireless transducer so that the model signals can be received and learned by the trainable transceiver. For example, the second receiver could include an infra-red sensing diode or a microphone.

The second receiver 34 preferably includes a radio frequency antenna to receive the model signals 18, but this antenna could be shared with the first receiver 20, the transmitter 30, or both. As described previously, the actuation requests 24 and the actuation commands 26 are preferably sufficiently different signals that it is likely for cost purposes that the first receiver and the transmitter will most likely use separate radio frequency antennas. The second receiver 34, on the other hand, preferably receives signals that are identical to the signals that it transmits with the antenna of transmitter 30, because the second receiver is intended to receive the model signals 18 that the trainable transceiver of the preferred embodiments learns to transmit with the transmitter 30. Therefore, even though various possible configurations of first receiver 20, second receiver 34, and transmitter 30 are possible, from some perspectives the most cost efficient design for the trainable transceiver will share the same antenna between the transmitter and the second receiver.

Further in accordance with this aspect of the invention, the trainable transceiver includes a controller in operative communication with the first and the transmitter. The controller is for controlling the operation of the transceiver. In the preferred embodiments according to this aspect of the invention, the controller 36 is operable to control the transceiver 10 in a one or more operating modes, including an active mode, as shown in FIGS. 2 and 3. Additionally, in the trainable preferred embodiments of the transceiver 10, the operating modes governed by the controller include a training mode. In the training mode the transceiver learns the signal format for the at least one actuation command 26 by receiving with the second receiver 34 the at least one model signal 18 and learning the signal format of the model signal. In the active mode the transceiver receives the at least one actuation request 24 and transmits the at least one actuation command 26, including the actuation command corresponding to the at least one actuation request.

In the preferred embodiments, the controller 36 includes a microprocessor or a micro-controller for controlling the operation of the transceiver 10. However, the controller may be discrete circuitry, for example, transistors, integrated circuits, passive components (such as resistors, capacitors, inductors, and the like), that perform the functions of controlling the operation of the transceiver. The controller 36 can be any electromechanical or other circuit configuration, including simple hardwiring or a plurality of microprocessors or microcontrollers and discrete circuitry, that performs the task of controlling the transceiver 10 in the various operating modes as described previously.

The controller 36 is the heart of the transceiver 10, and provides all of the necessary circuitry and software to operate the transceiver in the various operating modes of the preferred embodiments, including the training mode and the active mode. The transceiver preferably includes an operator interface 16, as described in detail previously, allowing the preferred embodiments of the transceiver to be operated manually by the user. The operator interface 16 is also preferably in operative communication with the controller 36. This also allows the user to transfer the transceiver 10 between the operating modes such as from the active mode to the training mode in the trainable embodiments of the transceiver.

In the preferred embodiments, the transceiver 10 can be used as a standard remote control device, such as for starting vehicles and opening garage doors and gates, in the active operating mode. Additionally, in the preferred embodiments the transceiver will accept the long distance actuation requests 24 and transmit the corresponding short distance actuation commands 26 while in the active mode. The active mode is the mode in which the transceiver 10 acts as a remote control providing both the standard features of a known remote control along with the enhanced capability of long distance remote control though the use of the first receiver 20 and the transmitter 30 by accepting the long distance actuation requests 24 and transmitting the corresponding short distance actuation commands 26. In the active mode, the transceiver 10 preferably acts as both a standard remote control and a long distance remote control. The preferred controller 36 provides all the necessary circuitry and software to control the first receiver 20, the transmitter 30, and all other peripheral devices such as the operator interface 16, when in the various operating mode. The controller 36 preferably includes circuitry and software to control the operation of the transceiver 10. Controller circuitry is well known in the art of remote control devices and the controller circuit may, for example, be similar to the that contained in known remote controls such as those described in U.S. Pat. Nos. 3,811,049, 4,425,647, 4,426,662, 4,897,718, and 4,928,778. Preferably, the controller 36 includes all the necessary circuitry and software to control the trainable preferred embodiments of the transceiver 10, for example, the controller may contain circuitry similar to that contained in known trainable remote controls such as those described in U.S. Pat. No. 4,825,200, as well as the various U.S. patents assigned to Prince Corporation disclosed previously. The controller 36 also includes the necessary circuitry, software, and any associated wiring or connections to interface with the first receiver 20, receive the actuation requests 24 of the first signal 22, recognize and decode actuation requests to determine if a valid actuation request has been received, and transmit the actuation command 26 corresponding to any valid actuation request 24 received. The controller 36 preferably includes software and circuitry similar to that contained in known paging devices, and known paging control devices, such as that disclosed in U.S. Pat. No. 5,608,655 assigned to Motorola, Incorporated. Preferably the controller 36 includes both short distance remote control circuitry and software as well as long distance paging circuitry and software, such as a paging decoder. Paging decoder circuits are common in the telecommunication industry today, and are often provided in the form of one or several discrete semiconductor devices.

In its simplest form according to the preferred embodiments, the controller 36 merges the circuitry and software of a known paging control device such as that disclosed in U.S. Pat. No. 5,608,655 and radio frequency remote control such as those disclosed in U.S. Pat. Nos. 5,854,593 and 5,903,326, as will be described in more detail below. The transceiver 10 preferably includes a signal generator to generate the second signal 32 used to transmit the actuation commands 26. The signal generator is preferably included in the controller circuitry. Signal generator design is well known in the art and the signal generator circuit may be, for example, similar to those described in U.S. Pat. Nos. 3,811,049 and 4,928,778. Preferably, the signal generator is a programmable signal generator and may be, for example, similar to that described in U.S. Pat. No. 5,854,893.

In accordance with another aspect of the invention, a transceiver is provided for transmitting and receiving signals. The transceiver includes a first receiver for receiving at least one actuation request. Each actuation request is a first signal for requesting the transceiver to transmit an actuation command corresponding to the actuation request. The preferred embodiments of this trainable transceiver 10 in accordance with this aspect of the invention are much the same as those for the first aspect of the invention described previously. For example, the first receiver 20 is preferably a radio frequency antenna and the first signal 22 is preferably a long distance radio frequency signal. More preferably, the first signal is a paging signal, much the same as previously described. The actuation command 26 is preferably second signal 32 that is a short distance radio signal, and more preferably the second signal comprises an actuation command to start a vehicle such as an automobile. Preferably, the trainable transceiver 10 is a trainable radio frequency remote control. Preferably, the trainable transceiver also includes an operator interface 16, much the same as previously described for the first aspect of the invention.

Further in accordance with this aspect of the invention, the trainable transceiver includes a transmitter for transmitting at least one actuation command including the actuation command corresponding to the at least one actuation request. Each actuation command is a second signal having a signal format. Again, the preferred embodiments according to this aspect of the invention are much the same as those according to the first aspect of the invention. For example, the transmitter 30 is preferably a short distance radio frequency antenna for transmitting the second signal 32 and the second signal is preferably a short distance radio frequency remote control signal.

Further in accordance with this aspect of the invention, the transceiver includes a second receiver for receiving at least one model signal. Each model signal is a radio frequency signal having the signal format corresponding to one of the at least one actuation commands. Again, the preferred embodiments according to this aspect of the invention are much the same as those for in accordance with the first aspect of the invention. For example, the second receiver 34 is preferably a short distance radio frequency antenna, and each model signal 18 is preferably a short distance radio frequency remote control signal from an existing remote control. The second receiver 34 preferably receives the model signals 18 in a training mode, as will be described in more detail below. The trainable transceiver 10 learns the model signals from the existing remote controls so that the transceiver can subsequently imitate the model signals when in the active mode, as will be described in more detail below.

Further in accordance with this aspect of the invention, the trainable transceiver includes a controller in operative communication with the first and second receivers and the transmitter. The controller is for controlling the operation of the transceiver. The controller is operable to control the transceiver in a training mode and an active mode. In the training mode, the transceiver learns the signal format for the at least one actuation command by receiving with the second receiver the at least one model signal and learning the signal format of the model signal. In the active mode, the transceiver receives the at least one actuation request and transmits the at least one actuation command including the actuation command corresponding to the at least one actuation request.

The preferred embodiments according to this aspect of the invention are much the same as those previously described for the first aspect of the invention. For example, the controller 36 preferably includes the circuitry and software necessary to control the transceiver in the various operating modes, including the training mode and the active mode. The controller 36 is preferably operatively coupled to an operator interface 16. The controller preferably includes a microprocessor or a microcontroller. The transceiver 10 preferably includes a signal generator, which is preferably part of the controller circuitry. The first receiver 20, second receiver 34 and the transmitter 30 preferably include one or more radio frequency antennas.

In accordance with yet another aspect of the invention, a method is provided for using a transceiver to control a devices remotely. The method includes receiving at least one actuation request at the transceiver. Each actuation request is a first signal requesting the transceiver to send an actuation command corresponding to the actuation request. In the preferred embodiments according to this aspect of the invention, the transceiver 10 is much the same as the transceiver according to the other aspects of the invention. For example, the first signal 22 carrying the actuation request 24 is preferably a long distance wireless signal, and is more preferably a long distance radio frequency signal such as a paging signal. The transceiver 10 according to some of the preferred embodiments is trainable transceiver that learns the signal format of a model signal 18 provided using an existing remote control in a training mode. The trainable transceiver imitates the signal format of the model signal 18 to transmit the actuation commands 26.

Further in accordance with this aspect of the invention, the method includes using the transceiver to send at least one actuation command including the actuation command corresponding to the at least one actuation request. Each actuation command is a second signal having a signal format. In the preferred embodiments according to this aspect of the invention, the transceiver 10 is much the same as the transceiver according to the other aspects of the invention. For example, the actuation commands 26 are preferably short distance wireless signals, and are more preferably short distance radio frequency signals for the remote control of subordinate devices 14, such as remotely starting vehicles. The transceiver 10 according to some of the preferred embodiments of this aspect of the invention may be a trainable transceiver, as previously described, and the trainable transceiver learns the signal format of at least one of the actuation commands 26 from a model signal 18 when in a training mode. The transceiver 10 preferably includes an operator interface 16 operatively coupled to the transceiver so that a user can manually access the transceiver, for example to send actuation commands 26 manually or to access the various operating modes of the transceiver. The transceiver preferably includes one or more antenna's for sending and receiving radio frequency signals 12.

Both the art of pagers and paging technology and the art of wireless remote control systems are well known, as summarized previously. The preferred embodiments of the transceiver 10 may be created either by building a transceiver from discrete components such as semiconductors, passive electrical components, switches, circuit boards, enclosures, and other such devices as is well known in the art. Alternately, the preferred embodiments of the transceiver 10 can made from subassemblies or complete paging and remote control units. The subassemblies may be procured or manufactured as completed circuit boards, or even as completed paging and remote control units that are operatively connected, such as wiring them together, to perform the functions of the transceiver. The method of manufacturing the transceiver doesn't matter. Preferred, non-limiting examples of the transceiver and its associated use that meet the requirements above are provided in the following.

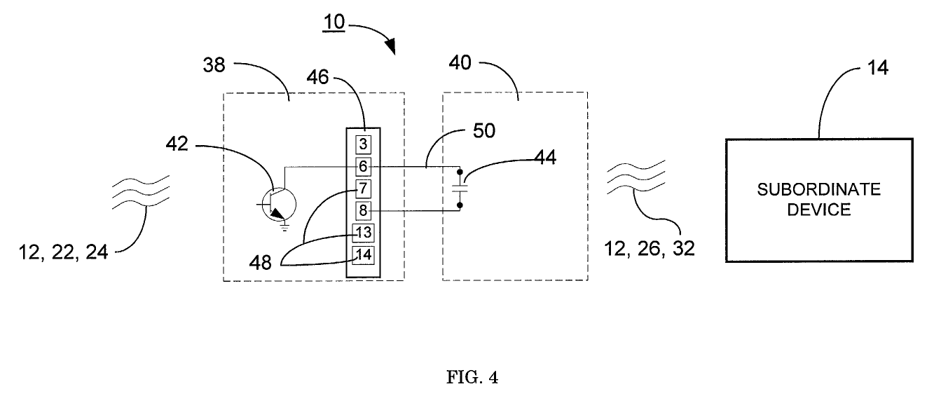

A specific, but illustrative, example of transceiver 10 of FIG. 1 can be constructed as follows. A paging device 38 that was a POCSAG Creatalink™ Messaging Receiver, hereafter revered to as CMR, manufactured by the Flex Architecture Division of Motorola Corporation of Boynton Beach, Fla. was procured from Fourth Dimension Industries of Holbrook, N.Y. The Fourth Dimension Industries P/N for the CMR 38 was J19WMW0050_E. The CMR 38 is a programmable paging controller that receives paging messages encoded in the POCSAG paging format over the existing paging infrastructure and decodes the messages. The decoded data can either be provided as output data in TTL or RS232 format or can be used to change the state of the up to eight digital output devices included in the CMR. The eight CMR digital outputs are isolated transistor outputs that may be programmed as a current source or a current sink to short to a high voltage signal or a low voltage signal in response to the reception of an appropriate paging signal. Refer to the Motorola Operation Manual number 6881132B49-0 for more detail regarding the operation of the CMR. These digital outputs are optically isolated outputs that actuate a transistor 42 that is connected to the output pins 48 of the output terminal 46 of the unit. The controller was programmed by Fourth Dimension Industries of Holbrook, N.Y. to short 4 of the 8 output transistors 42 high (current sources) and 4 of the 8 transistors to low (current sinks). One of the 4 digital outputs transistors 42 of the CMR 38 that was configured to be shorted to low (current sink) was hard wired with discrete wiring 50 directly across the actuation contacts 44 of a Code Alarm Sure Start SE model number MSS L type B alarm starter remote control 40 for a vehicle remote starter manufactured by Code Alarm, Inc. of Madison, Mich. again as shown in FIG. 4. The contacts 50 are normally part of a momentary switch that is included on the operator interface for the vehicle starter system remote control 40. The wiring diagram for the configuration used is provided in FIG. 4. The conductive actuation button associated with the manual switch for actuation the vehicle starter remote control 40 was removed to allow for the direct connection to the Motorola CMR 38. The device wired as described above was accessed by dialing into the paging phone number assigned to the Motorola CMR 38 and the actuation code 26, a programmable 0 to 10 digit numerical code for the CMR, was entered by the telephone into the Motorola CMR's paging access network 28. The transceiver 10 of this example was in close proximity to the subordinate vehicle 14 corresponding to the vehicle starter remote control 40 (the vehicle that is normally started by this remote control unit manually). Within less than about one minute, and often times in 10 or 15 seconds of accessing the Motorola CMR's paging controller network, the vehicle in communication with the vehicle starter remote control started.

Another specific, but illustrative, example of transceiver 10 of FIG. 1 can be constructed as follows. In a manner similar to that described previously for example 1, the Motorola POCSAG CMR 38 of example 1 was wired to the one set of the manual switch contacts 44 for another remote control 40 that was a Homelink™ trainable radio frequency remote control manufactured by Prince Corporation of Holland, Mich. Following the instruction manual provided for the Homelink™ trainable remote control 40, the Homelink™ remote control was trained to copy the signal format of a model signal 18 provided by a P/N ACSR1G garage door opener remote control by Genie Company, Inc. of Alliance, Ohio for the Genie Company Pro Max model number PMX500IC/B garage door opener system. After training the trainable remote control 40, again the Motorola CMR 38 was accessed through the paging network 28 by dialing into the phone circuit assigned to the CMR 38. The code assigned to actuate the CMR was entered into the paging circuit using the telephone. The transceiver of this example was in close proximity to the garage door actuated by Genie Corporation model PMX500IC/B garage door opener system corresponding to the Genie model ACSR1G remote control. Again, within less than about one minute of accessing the Motorola CMR 38 through the paging network 28, the garage door opened as requested.

Additionally, the transceivers 10 of these two presently preferred examples were also accessed using e-mail and by way of the pager service provider's web site to actuate the devices (start the car and open the garage door with the respective transceivers described in the examples provided above). This adds further capabilities to and features to the transceiver 10, making it more useful.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

What is claimed is:

1. A transceiver for transmitting and receiving signals, the transceiver comprising:
a first receiver for receiving at least one actuation request, each actuation request comprising a first signal for requesting the transceiver to transmit an actuation command corresponding to the actuation request;
a transmitter for transmitting at least one actuation command including the actuation command corresponding to the at least one actuation request, each actuation command comprising a second signal having a signal format; and
a controller in operative communication with the first receiver and the transmitter for controlling the operation of the transceiver.

2. The transceiver recited in claim 1, wherein:
the transceiver further comprises a second receiver for receiving at least one model signal, each model signal comprising a radio frequency signal having the signal format corresponding to one of the at least one actuation commands; and
the controller is further in operative communication with the second receiver, the controller for controlling the operation of the transceiver, the controller being operable to control the transceiver in a training mode, the transceiver learning the signal format for the at least one actuation command in the training mode by receiving with the second receiver the at least one model signal and learning the signal format of the model signal.

3. The transceiver recited in claim 1, wherein the transceiver further comprises an operator interface operatively coupled to the controller.

4. The transceiver recited in claim 2, wherein the operator interface comprises at least one switch.

5. The transceiver recited in claim 4, wherein the at least one switch comprises a momentary switch.

6. The transceiver recited in claim 2, wherein the operator interface includes at least one switch for transmitting the at least one actuation command when the switch is actuated.

7. The transceiver recited in claim 1, wherein the transceiver comprises a remote control for remotely actuating one or more devices using the at least one actuation command.

8. The transceiver recited in claim 1, wherein the transceiver comprises a vehicle remote control for remotely starting a vehicle using the at least one actuation command.

9. The transceiver recited in claim 8, wherein the actuation request comprises a request for transmitting the actuation command corresponding to the actuation request for remotely starting the vehicle.

10. The transceiver recited in claim 8, wherein the vehicle comprises an automobile.

11. The transceiver recited in claim 2, wherein the transceiver comprises a remote control for opening a door using the at least one actuation command.

12. The transceiver recited in claim 1, wherein the first signal comprises a long distance radio frequency signal.

13. The transceiver recited in claim 12, wherein the first signal comprises a paging signal.

14. The transceiver recited in claim 13, wherein the actuation command corresponding to the actuation request comprises a short distance radio frequency signal.

15. The transceiver recited in claim 14, wherein the short distance radio frequency signal is a command to start a vehicle.

16. The transceiver recited in claim 1, wherein the actuation command comprises a command to start a vehicle.

17. The transceiver recited in claim 16, wherein the actuation command corresponding to the actuation request comprises a command to start a vehicle.

18. The transceiver recited in claim 1, wherein the second signal comprises a short distance radio frequency signal.

19. The transceiver recited in claim 1, wherein the first receiver and the transmitter comprise a radio frequency antenna.

20. The transceiver recited in claim 2, wherein the second receiver comprises a radio frequency antenna.

21. The transceiver recited in claim 1, wherein the controller comprises a paging signal decoder.

22. The transceiver recited in claim 1, wherein the transceiver comprises a single enclosure.

23. A transceiver for transmitting and receiving signals, the transceiver comprising:
a first receiver for receiving at least one actuation request, each actuation request comprising a first signal for requesting the transceiver to transmit an actuation command corresponding to the actuation request;
a transmitter for transmitting at least one actuation command including the actuation command corresponding to the at least one actuation request, each actuation command comprising a second signal having a signal format;
a second receiver for receiving at least one model signal, each model signal comprising a radio frequency signal having the signal format corresponding to one of the at least one actuation commands; and
a controller in operative communication with the first and second receivers and the transmitter, the controller for controlling the operation of the transceiver, the controller being operable to control the transceiver in a training mode and an active mode, the transceiver learning the signal format for the at least one actuation command in the training mode by receiving with the second receiver the at least one model signal and learning the signal format of the model signal, the transceiver receiving the at least one actuation request and transmitting the at least one actuation command including the actuation command corresponding to the at least one actuation request in the active mode.

24. The transceiver recited in claim 23, wherein the transceiver further includes an operator interface operatively coupled to the controller.

25. The transceiver recited in claim 23, wherein the transceiver comprises a remote control for remotely actuating one or more devices using the at least one actuation command.

26. The transceiver recited in claim 23, wherein the transceiver comprises a vehicle remote control for remotely starting a vehicle using the at least one actuation command.

27. The transceiver recited in claim 26, wherein the actuation request comprises a request for transmitting the corresponding actuation command for remotely starting the vehicle.

28. The transceiver recited in claim 23, wherein the first signal comprises a long distance radio frequency signal.

29. The transceiver recited in claim 28, wherein the first signal comprises a paging signal.

30. The transceiver recited in claim 29, wherein the actuation command corresponding to the actuation request comprises a short distance radio frequency signal.

31. The transceiver recited in claim 30, wherein the short distance radio frequency signal comprises a command to start a vehicle.

32. The transceiver recited in claim 23, wherein the second signal comprises a short distance radio frequency signal.

33. The transceiver recited in claim 23, wherein the first receiver, the second receiver, and the transmitter comprise a radio frequency antenna.

34. A method for using a transceiver to control a device remotely, the method comprising:
a) receiving at least one actuation request at the transceiver, each actuation request comprising a first signal requesting the transceiver to send an actuation command corresponding to the actuation request;
b) using the transceiver to send at least one actuation command including the actuation command corresponding to the at least one actuation request, each actuation command comprising a second signal having a signal format.

35. The method recited in claim 34, wherein the method further comprises:
receiving at least one model signal at the transceiver, each model signal having a signal format corresponding to one of the at least one actuation commands, the transceiver learning the signal format of the model signal in a training mode.

36. The method recited in claim 34, wherein the transceiver further includes an operator interface operatively coupled to the transceiver.

37. The method recited in claim 34, wherein the at least one actuation command comprises a command to start a vehicle remotely.

38. The method recited in claim 37, wherein the actuation request comprises a request for transmitting the corresponding actuation command for remotely starting the vehicle.

39. The method recited in claim 34, wherein the first signal comprises a long distance radio frequency signal.

40. The method recited in claim 39, wherein the first signal comprises a paging signal.

41. The method recited in claim 40, wherein the actuation command corresponding to the actuation request comprises a short distance radio frequency signal.

42. The method recited in claim 34, wherein the second signal comprises a short distance radio frequency signal.

43. The method recited in claim 35, wherein the transceiver further includes an antenna for sending or receiving at least one of the first signal, the second signal, and the model signal.
